(19) United States
(12) Patent Application Publication
(10) Pub. No.: US 2023/0381947 A1
(43) Pub. Date: Nov. 30, 2023

(54) APPENDAGE WORK SHARING APPARATUS

(71) Applicant: University of Central Florida Research Foundation, Inc., Orlando, FL (US)

(72) Inventors: Joon-Hyuk Park, Orlando, FL (US); Gabriel Rios Carbonell, Orlando, FL (US); Eric Frankle, Orlando, FL (US)

(21) Appl. No.: 18/321,149

(22) Filed: May 22, 2023

Related U.S. Application Data
(60) Provisional application No. 63/345,295, filed on May 24, 2022.

(51) Int. Cl. B25J 9/00; B25J 9/10; B25J 9/12; B25J 13/08

(52) U.S. Cl. CPC B25J 9/0006; B25J 9/1045; B25J 9/12; B25J 13/087

(57) ABSTRACT

Described herein relates to an apparatus and method of capturing a movement of a targeted muscle group of a user and transferring it to another muscle group of the user. The appendage work sharing device comprises a cable pulley system, creating an external mechanical pathway to transfer upper limb joint motion or force to the lower limb joints. Accordingly, by creating the external mechanical pathway, the appendage work sharing apparatus provides a self-regulated and self-powered means to assist lower limbs during ambulatory movements using upper limb muscles, reducing the lower limb muscle work (e.g., electromyography) during several ambulatory movements (e.g., sit to stand and step up) using upper limb muscles (e.g., shoulders, biceps, or triceps).

### CROSS-REFERENCE TO RELATED APPLICATIONS

This nonprovisional application claims the benefit of U.S. Provisional Application No. 63/345,295 entitled “APPENDAGE WORK SHARING APPARATUS” filed May 24, 2022 by the same inventors, all of which is incorporated herein by reference, in its entirety, for all purposes.

### BACKGROUND OF THE INVENTION

### 1. Field of the Invention

This invention relates, generally, to mobility assistance. More specifically, it relates to an apparatus and method for capturing a movement (e.g., a muscle exertion) about at least one joint of a user and transferring the captured movement to at least one alternative joint of the user.

### 2. Brief Description of the Prior Art

Ambulatory assistive devices, such as canes, walkers and crutches provide postural balance and reduce the weight-bearing load of the affected lower limbs. However, using these ambulatory assistive devices can lead to a significant reduction in lower limb muscle activations which is counterproductive to intervention and rehabilitation goals. While recent advances in technology have enabled the use of exoskeletons, these recent technologies also include extremely high cost, bulk, weight, and power demand (e.g., limited battery capacity and operation time) which limit their accessibility and usability for the general population.

To overcome these limitations in powered assistive devices, passive devices have been developed that can harness the kinetic energy during lower limb deceleration and utilize this harnessed energy to assist the movement of the leg, thus reducing the net energetic cost of the user during ambulatory movements. A passive lower-limb exoskeleton was developed to reduce the lower limb joint work by using artificial tendons acting parallel with the muscle tendons in the leg or to assist the functions of calf muscles and Achilles' tendon, or to provide walking assistance through the spring-damper mechanism by partially replacing the function of lower limb muscles, thus reducing the cost of transport. While these designs focus on exploiting the feasibility to use one of the muscle groups from agonist and antagonist muscle pairs to aid mobility, it is not applicable for people whose lower limb motor control and muscle functions are hindered by age, neuromuscular conditions, or injuries to the extent where external power is required to maintain mobility.

Bipedal locomotion allows upper limbs to be free, requiring minimal effort from the upper limb muscles during walking, primarily arm swing motions help maintain gait and postural stability. Human arms and legs exhibit resemblance in terms of the number of joints and degrees of freedom that each joint possesses. Besides the anatomical similarities, kinematic patterns of upper and lower body joints during ambulatory movements are cyclic and temporally aligned. Based on the nature of this kinematic coupling, harnessing the kinetic energy from upper limb joint motion and transferring it to lower limb joints could provide a self-regulated and self-powered means to assist lower limb work during ambulatory movements.

Such a strategy can also promote activations and exercise on the muscles in both upper and lower limbs, preventing many aging-related issues such as sarcopenia. There are several energy harvesting systems designed to capture energy from upper limb motions, employing the said concept; however, their functions are limited only for use as a supplementary energy source for low-power wearable devices. Just as how canes, walkers, crutches are prescribed and used, a work sharing device is one that has the potential to be used as an ambulatory assistive device.

Accordingly, what is needed is lightweight, self-regulated, self-powered appendage work sharing apparatus, which provides upper-limb assisted mobility without the need of an external power source. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to an appendage work sharing apparatus. In an embodiment, the appendage work sharing apparatus may comprise the following: (a) a linkage component comprising at least one pulley, at least two cables, or both, such that the at least two cables may be in mechanical communication with the at least one pulley, such that the linkage component may have a variable tension; and (b) a plurality of modules in mechanical communication with the linkage component, such that each of the plurality of modules may be disposed at a predetermined joint of a user. In addition, in this embodiment at least one module of the plurality of modules may be configured to transfer a force at the predetermined joint, via the linkage component, to at least one alternative module of the plurality of modules disposed about at least one alternative joint.

In some embodiments, the plurality of modules may further comprise: (i) a base; (ii) at least one cable drum temporarily affixed to the base, such that the linkage component may be disposed about at least a portion of the at least one cable drum; and (iii) at least one ratchet mechanism in mechanical communication with the at least one cable drum, such that the at least one ratchet mechanism may be configured to alternate the at least one cable drum from a disengaged stage to an engaged stage and/or an engaged state to a disengaged state, automatically adjusting the tension of the linkage component. Additionally, in these other embodiments, the plurality of modules may further comprise at least one assistance drum temporarily affixed to at least one alternative base, such that the at least one assistance drum may be disposed about at least a portion of a ball-and-socket joint of the user, such that a center of the at least one assistance drum may be positioned at a center of the ball-and-socket joint.

In some embodiments, when the at least one ratchet mechanism is in the engaged state, the linking component may comprise a tension, pairing at least one cable drum of at least one module of the plurality of module with the at least one cable drum of at least one alternative module of the plurality of modules. In this manner, when the at least one ratchet mechanism is in the disengaged state, the linking component may comprise a minimal tension, unpairing at least one cable drum of at least one module of the plurality of module with the at least one cable drum of at least one alternative module of the plurality of modules.

Moreover, in some embodiments, the at least one assistance drum may be configured capture abduction and/or adduction at the ball-and-socket joint of a user. As such, in these other embodiments, the at least one cable drum may also be configured to capture flexion, and/or extension at the predetermined joint of the user.

In some embodiments, the at least one cable drum and/or the at least one assistance drum of at least one module of the plurality of modules may be in mechanical communication with the at least one cable drum and/or the at least one assistance drum of at least one alternative module of the plurality of modules, via the linkage mechanism. In addition, the linkage component may comprise a motion coupling ratios may include but is not limited the following group comprising of 1:1, 1.5:1, and/or 2:1 between the at least one module in mechanical communication with the at least one alternative module.

In some embodiments, the work sharing apparatus may further comprise the following: (A) a computing device having at least one processor communicatively coupled to at least one sensor, such that the at least one sensor may be configured to detect an exertion by at least one muscle in mechanical communication with the predetermined joint, such that the at least one sensor may be disposed about at least one portion of each of the plurality of modules; and (B) at least one motor in mechanical communication with the linking component, such that the at least one motor may be disposed about at least portion of the base of each of the plurality of modules, such that the at least one motor may be communicatively coupled with the at least one processor of the computing device.

In some embodiments, subsequent to the at least one sensor detecting an exertion by at least one muscle mechanical communication the predetermined joint, the at least one processor may be configured to actuate the at least one motor at the predetermined joint, automatically reducing muscle exertion by the at least one muscle at the predetermined joint, in real-time, simultaneously with the movement of the user.

Moreover, another aspect of the present disclosure pertains to a system for capturing a movement of a targeted muscle group of a user and/or transferring it to at least one alternative muscle group of the user. In an embodiment, the system may comprise the following: (a) a linkage component comprising at least one pulley, at least two cables, or both, such that the at least two cables may be in mechanical communication with the at least one pulley, such that the linkage component may comprise a variable tension; (b) a plurality of modules in mechanical communication with the linkage component, such that each of the plurality of modules may be positioned at a predetermined joint of a user; (c) at least one arm brace; and (d) at least one leg brace. In this embodiment, at least one portion of at least one of plurality of modules associated with an upper appendage joint of the user may be disposed about at least one portion of a surface of the at least one arm brace. In this manner, int his embodiment, at least one portion of at least one alternative module of the plurality of modules associated with a lower appendage joint of the user may also be disposed about at least one portion of a surface of the at least one leg brace. As such, at least one module of the plurality of modules may be configured to transfer a force at the predetermined joint to at least one alternative module of the plurality of modules.

In some embodiments, the plurality of modules may further comprise: (i) a base; (ii) at least one cable drum temporarily affixed to the base, such that the linkage component may be disposed about at least a portion of the at least one cable drum; and (iii) at least one ratchet mechanism in mechanical communication with the at least one cable drum, such that the at least one ratchet mechanism may be configured to alternate the at least one cable drum from a disengaged stage to an engaged stage and/or an engaged state to a disengaged state, automatically adjusting the tension of the linkage component. Additionally, in these other embodiments, the plurality of modules may further comprise at least one assistance drum temporarily affixed to at least one alternative base, such that the at least one assistance drum may be disposed about at least a portion of a ball-and-socket joint of the user, such that a center of the at least one assistance drum may be positioned at a center of the ball-and-socket joint.

In some embodiments, the system may further comprise a shoulder harness, such that at least one additional alternative module of the plurality of modules associated with at least one alternative upper appendage joint of the user may be disposed about at least one portion of a surface of the shoulder harness. Additionally, in these other embodiments, the at least one cable drum and/or the at least one assistance drum of at least one module of the plurality of modules may be in mechanical communication with the at least one cable drum and/or the at least one assistance drum of at least one alternative module of the plurality of modules, via the linkage mechanism.

In some embodiments, the work sharing apparatus may further comprise the following: (A) a computing device having at least one processor communicatively coupled to at least one sensor, such that the at least one sensor may be configured to detect an exertion by at least one muscle mechanical communication with the predetermined joint, such that the at least one sensor may be disposed about at least one portion of each of the plurality of modules; and (B) at least one motor in mechanical communication with the linking component, such that the at least one motor may be disposed about at least portion of the base of each of the plurality of modules, such that the at least one motor may be communicatively coupled with the at least one processor of the computing device.

In some embodiments, subsequent to the at least one sensor detecting an exertion by at least one muscle mechanical communication with the predetermined joint, the at least one processor may be configured to actuate the at least one motor at the predetermined joint, automatically reducing muscle exertion by the at least one muscle at the predetermined joint, in real-time, simultaneously with the movement of the user.

Furthermore, an additional aspect of the present disclosure pertains to a method of capturing a movement of a targeted muscle group of a user and transferring it to at least one alternative muscle group of the user, via an appendage work sharing apparatus. In an embodiment the method may comprise the following: (a) affixing the appendage work sharing apparatus to the user, the appendage work sharing apparatus comprising: (i) a linkage component comprising at least one pulley and/or at least two cables, such that the at least two cables may be in mechanical communication with the at least one pulley, such that the linkage component may comprise a variable tension; and (ii) a plurality of modules in mechanical communication with the linkage component, such that each of the plurality of modules may be disposed at a predetermined joint of a user, such that at least one module of the plurality of modules may be configured to transfer a force at the predetermined joint, via the linkage component, to at least one alternative module of the plurality of modules disposed about at least one alternative joint; (b) engaging, via the at least one ratchet mechanism, the appendage work sharing apparatus; and (c) performing, via the appendage work sharing apparatus a plurality of exercises, activities, or both, such that the movement of the targeted muscle group may be transferred to at least one alternative muscle group of the user, reducing a total muscle exertion of the targeted muscle group during the plurality of exercises and/or activities.

In some embodiments, the method may further comprise the steps of: (A) transmitting, via at least one sensor communicatively coupled to a computing device associated with the appendage work sharing apparatus, the computing device having at least one processor, exertion data relating to the total muscle exertion of the targeted muscle group during the plurality of exercises, activities, or both; (B) actuating, via the at least one processor, at least one motor disposed about at least a portion of each of the plurality of modules, the at least one motor being in mechanical communication with the linking component, such that the at least one motor may be communicatively coupled to the at least one processor; and (C) assisting, via at least one motor, transfer of the movement of the targeted muscle group to at least one alternative muscle group of the user based on the transmitted exertion data, optimizing total muscle reduction of the targeted muscle group during the plurality of exercises, activities, or both.

In some embodiments, the appendage work sharing apparatus may be lightweight, self-regulated, and/or self-powered, such that, for example, upper-limb assisted mobility may be provided without the need of an external power source. Additionally, the appendage work sharing apparatus may be configured to capture the work from elbow joint and/or shoulder joint and transfer it to the knee joint and/or hip joint, respectively. As such, in these other embodiments, the appendage work sharing apparatus may be configured to create an external mechanical pathway to facilitate the use of alternative muscle groups to aid a targeted muscle group in performance of a plurality of exercises and/or a plurality of activities muscle efforts during walking, stair ascending/descending, and sit-to-stand.

In some embodiments, the appendage works sharing apparatus may offer an external mechanical pathway to transmit motion and force from the upper limb joints/muscles to the lower limb joints, allowing lower limb muscles to share the work with upper limb muscles. Accordingly, by creating an external mechanical pathway, the appendage work sharing apparatus may effectively reduce the work done by the lower limbs in ambulatory movements. In this manner, in these other embodiments, anyone with lower body conditions and/or gait-impairing disorders or diseases may potentially use this invention to gain ambulatory movement functions. Moreover, the appendage work sharing apparatus may be a cable-driven device, such that the appendage work sharing apparatus may be configured to capture the work from the elbow joint and/or the shoulder joint and/or transfer it to the knee joint and/or hip joint, respectively, of the user.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is an exemplary configuration of an appendage work sharing apparatus, according to an embodiment of the present disclosure.

FIG. 2A is an exemplary configuration of the linkage mechanism of an appendage work sharing apparatus, according to an embodiment of the present disclosure.

FIG. 2B is an alternative exemplary configuration of the linkage mechanism of an appendage work sharing apparatus of FIG. 2A, including a direct drive, according to an embodiment of the present disclosure.

FIG. 3 is a perspective view of a pulley system within a linking component of an appendage work sharing apparatus, according to an embodiment of the present disclosure.

FIG. 4 is an exemplary configuration of a cuff of an appendage work sharing apparatus, according to an embodiment of the present disclosure.

FIG. 5 is an exemplary configuration of a knee orthoses of an appendage work sharing apparatus, according to an embodiment of the present disclosure.

FIG. 6 is a perspective view of an exemplary configuration of a backpack frame of an appendage work sharing apparatus, according to an embodiment of the present disclosure.

FIG. 7 is an alternative perspective view of the backpack frame of FIG. 6, according to an embodiment of the present disclosure.

FIG. 8 is a perspective view of an exemplary configuration of an appendage work sharing apparatus affixed to a user, according to an embodiment of the present disclosure.

FIG. 9A is a perspective view of an initial position for a first exercise using an appendage work sharing apparatus, according to an embodiment of the present disclosure.

FIG. 9B is a perspective view of a final position for a first exercise using an appendage work sharing apparatus, according to an embodiment of the present disclosure.

FIG. 10A is a perspective view of an initial position for a second exercise using an appendage work sharing apparatus, according to an embodiment of the present disclosure.

FIG. 10B is a perspective view of a final position for a second exercise using an appendage work sharing apparatus, according to an embodiment of the present disclosure.

FIG. 11A is a perspective view of an initial position for a third exercise using an appendage work sharing apparatus, according to an embodiment of the present disclosure.

FIG. 11B is a perspective view of a final position for a third exercise using an appendage work sharing apparatus, according to an embodiment of the present disclosure.

FIG. 12 is a plot illustrating an average linear envelope of an EMG during a first, a second, and a third exercise of a user, according to an embodiment of the present disclosure.

FIG. 13 is a graph illustrating an integrated EMG of rectus femoris in a first, a second, and a third exercise of a user, according to an embodiment of the present disclosure.

FIG. 14 is an exemplary flow chart depicting the steps of a method of capturing a movement of a targeted muscle group of a user and transferring it to another muscle group of the user, according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention. Elements/components shown in diagrams are illustrative of exemplary embodiments of the disclosure and are meant to avoid obscuring the disclosure. Any headings, used herein, are for organizational purposes only and shall not be used to limit the scope of the description or the claims. Furthermore, the use of certain terms in various places in the specification, described herein, are for illustration and should not be construed as limiting.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compacts disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

As used herein, the term “communicatively coupled” refers to any coupling mechanism known in the art, such that at least one electrical signal may be transmitted between one device and one alternative device. Communicatively coupled may refer to Wi-Fi, Bluetooth, wired connections, wireless connection, and/or magnets. For ease of reference, the exemplary embodiment described herein refers to Wi-Fi and/or Bluetooth, but this description should not be interpreted as exclusionary of other electrical coupling mechanisms.

As used herein, the term “about” or “roughly” means approximately or nearly and in the context of a numerical value or range set forth means±15% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Appendage Work-Sharing Apparatus

The present disclosure pertains to an apparatus and method for appendage work-sharing, such that a movement of a targeted appendage may be captured and/or may be transferred to at least one alternative appendage of the user. For example, an appendage movement may include but is not limited to elbow joint motion, shoulder joint motion, hip joint motion, and/or knee joint motion. In an embodiment, the work sharing apparatus may be configured to capture movement of the elbow and/or shoulder joint motions and subsequently transfer them to the knee and/or hip joints, and/or vice versa, respectively. In some embodiments, the work sharing apparatus may include a cable system, optimizing the weight and/or wearability of the work sharing apparatus.

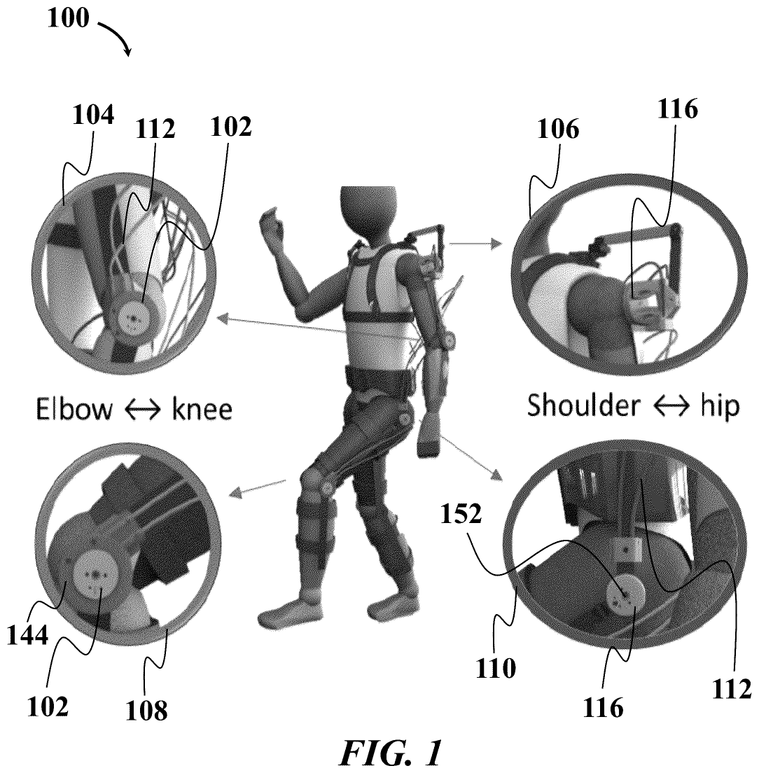

FIG. 1 depicts an exemplary configuration of an appendage work sharing apparatus 100, according to an embodiment of the present disclosure. In an embodiment, as shown in FIG. 1, appendage work sharing apparatus 100 may comprise of at least four modules, including but not limited to an elbow module 104, a shoulder module 106, a knee module 108, and a hip module 110. As such, in this embodiment, appendage work sharing apparatus may be communicatively coupled to a computing device having at least one processor. Accordingly, at least one sensor communicatively coupled to the computing device may be disposed about each module (e.g., elbow module 104, shoulder module 106, knee module, 108, and/or hip module 110), allowing the at least one sensor to collect exertion data pertaining to the surrounding muscular groups. In an embodiment, appendage work sharing apparatus 100 may be configured to conform to each user, such that appendage work sharing apparatus 100 may consist of at least one of the above described modules, according to the need of the user. In this manner, in an embodiment, appendage work sharing apparatus 100 may comprise at least one clip and/or band that may be adjustable, so an individual with a first height and/or build may adjust the at least one clip and/or harness to conform to their body and then at least one alternative individual with a second height and/or build may adjust the at least one clip and/or band and have appendage work sharing apparatus 100 to their body and/or shape.

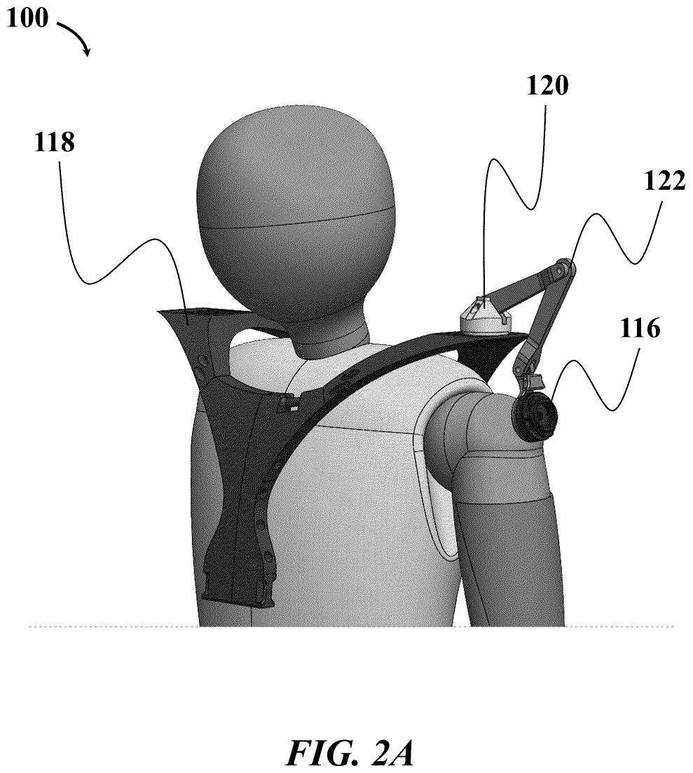

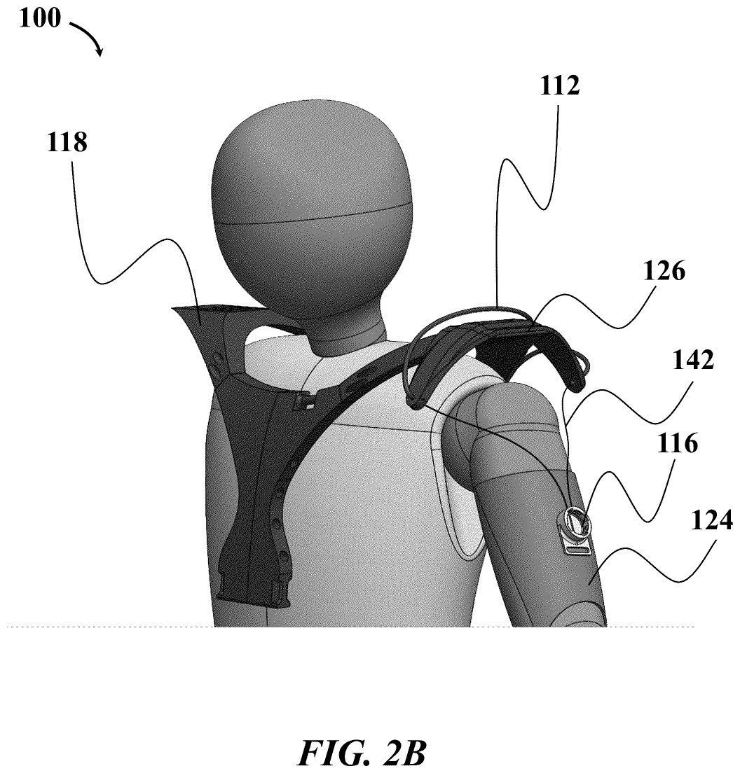

Additionally, as shown in FIGS. 1-2B, elbow module 104 and/or knee module 108 may include at least one cable drum 102 mounted at least one joint of the user (e.g., a knee joint, an elbow joint, etc.) in order to capture a flexion and/or extension at the at least one joint of the user. Moreover, in this embodiment, shoulder module 106 and/or hip module 110 may comprise at least one assistance drum 116 on the upper joint of the lower appendage and/or the upper appendage of the user (e.g., a shoulder joint, a hip joint, etc.). Accordingly, in this embodiment, assistance drum 116 may be affixed to appendage work sharing apparatus 100 at the at least one shoulder of the user, such that assistance drum may be in mechanical communication with a linkage component of appendage work sharing apparatus 100 (e.g., cable and/or pulley system), allowing the linkage component to capture flexion and/or extension of the upper appendage of the user. As such, in this embodiment, the linkage component may include, but is not limited to at least two pulley cables 112, at least one pulley system 144, at least one abduction and/or adduction joint 122, at least one revolute joint 120, at least one assistance drum 116, and/or at least one cable drum 102.

As shown in FIGS. 1-3, in an embodiment, cable drum 102 and/or assistance drum 116 may be configured to interface with the at least two pulley cables 112 of the linkage component. In this manner, the at least two pulley cables 112 may be configured to accommodate bidirectional motion transfer. As such, in this embodiment, each of the at least two pulley cables 112 may be in mechanical communication (e.g., interfaced) with cable drum 102 and/or assistance drum 116, such that each of the at least two pulley cables 112 may be responsible for a single directional motion. Accordingly, the activation of the appendage work sharing apparatus may be done by tensioning the at least two cables 112, via a ratchet mechanism 152 of the linkage component. In this embodiment, the linkage component may be configured to allow at least one upper appendage module (i.e., elbow module 104 and/or shoulder module 106) to be in mechanical communication with at least one lower appendage module (i.e., knee module 108 and/or hip module 110), such that the appendage work sharing apparatus may be configured to capture and/or transfer a movement and/or exerted force of the at least one upper appendage module to the at least one lower appendage module.

FIGS. 2A-2B depict the linkage component of appendage work sharing apparatus 100 with respect to shoulder module 106, according to an embodiment of the present disclosure. In an embodiment, as shown in FIGS. 2A-2B, the linkage component may be configured to allow at least one upper appendage (e.g., arm and/or shoulder) of the user to achieve and/or perform all degrees of freedom and/or movement. Moreover, in this embodiment, the linkage component may be in mechanical communication with assistance drum 116 configured to be temporarily affixed directly to a shoulder harness 118 (e.g., temporarily affixed to a shoulder plate 126 of shoulder harness 118). As such, assistance drum 116 may be configured to be disposed about at least a portion of shoulder harness 118, such that assistance drum 116 may have a center that is aligned roughly with the center of rotation of a ball-and-socket joint (e.g., glenohumeral joint (i.e., shoulder joint)) to allow for flexion and/or extension of the shoulder joint and/or hip joint by the user.

Accordingly, in an embodiment, as shown in FIG. 2A, the linkage component may also comprise at least one abduction and/or adduction joint 122, within shoulder module 106 allowing the shoulder of the user to fully perform abduction and/or adduction without impediment, and within hip module 110, allowing the hip of the user to fully perform abduction and/or adduction. Additionally, as depicted in FIG. 2A, in this embodiment, the linkage component may have a revolute joint 120, such that a user may fully perform internal and/or external rotation of the shoulder. In this manner, hip module 110 of appendage work sharing apparatus 100 may also comprise a revolute joint, such that the hip of the user may fully perform internal and/or external rotation. Furthermore, in this embodiment, abduction and/adduction joint 122 of the linkage component may be in mechanical communication with revolute joint 120 in both shoulder module 106 and hip module 110 of appendage work sharing apparatus 100, such that the ball-and-socket joint of the user may fully perform all aspects of rotation, without impediment.

As such, as shown in FIG. 2B, in another embodiment, the linkage component may comprise a configuration such that assistance drum 116 may not be disposed about shoulder harness 118, such that assistance drum 116 may not have a center aligned roughly with the center of rotation of the shoulder. In this manner, in this other embodiment, the linkage component may be configured to capture the shoulder flexion and/or extension of the user, via a direct drive. As such, the direct drive may comprise at least one cable 142, such that the at least one cable may connect an upper arm and the shoulder joint, via assistance drum 116 disposed about at least one portion of an arm brace 124. In addition, as shown in FIG. 2B, in this other embodiment, the linkage component may allow for unrestricted abduction and/or adduction, enabling appendage work sharing apparatus 100 to capture flexion and/or extension of the shoulder joint, while also allowing free motion in the other two degrees of freedom of the shoulder joint.

In this manner, in some embodiments, the linkage component of appendage work sharing apparatus 100 may be configured to capture the hip flexion and/or extension of the hip joint of the user, via the direct drive, as well. Accordingly, assistance drum 116 may be disposed about at least one portion of a leg brace 138, such that the linkage component may allow for unrestricted abduction and/or adduction of the hip joint, enabling appendage work sharing apparatus 100 to capture flexion and/or extension of the hip joint, while also allowing free motion in the other two degrees of freedom of the hip joint.

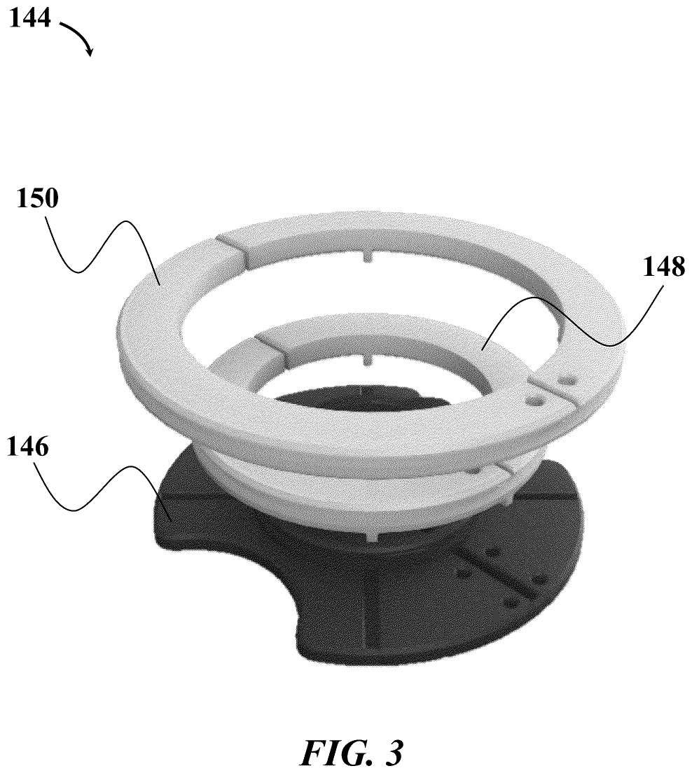

Moreover, FIG. 3, in conjunction with FIGS. 1-2B, depicts a pulley system 144 of the linking component of appendage work sharing apparatus 100, according to an embodiment of the present disclosure. In an embodiment, pulley system 144 may comprise a base 146 and at least two addition cable drums 148, 150, such that the linking component may be configured to adjust the ratio of motion transmission between the paired joints (e.g., elbow module 104 and knee module 108 and/or shoulder module 106 and hip module 110). Additionally, base 146 may be configured to be disposed about at least a portion of the predetermined joint (e.g., knee, elbow, shoulder, hip). In this embodiment, ratchet mechanism 152 may be temporarily affixed to base 146 of pulley system 144, such that the activation and/or deactivation of appendage work sharing apparatus 100 may be optimized. Moreover, in this embodiment, the at least two additional cable drums 148, 150 may be sized differently (e.g. a small drum 148, a large drum 150), and/or may be temporarily affixed attached to base 146 with a fastening mechanism. Furthermore, in an embodiment, the at least one two additional cable drums 148, 150 may be sized according to the user, such that different appendages may incorporate different sized cable drums 102.

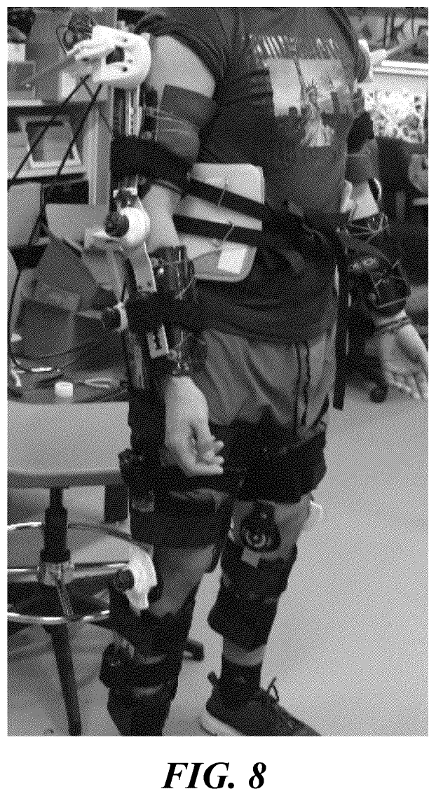

In an embodiment, pulley system 144 of appendage work sharing apparatus 100 may have a plurality of motion coupling ratios comprising a range of at least 1:1 to at most 10:1, encompassing every integer in between. For example, in some embodiments, appendage work sharing apparatus 100 may comprise three motion coupling ratios of 1:1, 1.5:1 and/or 2:1, between the paired upper module and the lower module (e.g., elbow module 104 and knee module 108 and/or shoulder module 106 and hip module 110, respectively). Additionally, in this embodiment, pulley system 144 and/or the at least two cables 112, as shown in FIG. 8, in conjunction with FIGS. 1-3, may be configured to assure that the tension within each of the modules (i.e., elbow module 104, shoulder module 106, knee module 108, and/or hip module 110) may have a constant moment arm to the joint center, throughout the entire range of motion of the joint of each module. Accordingly, the cable routing path of the at least two cables 112, in association with pulley system 144, may be oriented such that a contact point of the at least two cables 112 on cable drum 102 and/or assistance drum 116 may always be tangential to cable drum 102 and/or assistance drum 116, such that pulley system and/or the at least two cables 112 may provide a constant moment arm at each module of appendage work sharing apparatus 100.

Another aspect of the present disclosure is that appendage work sharing apparatus 100 may comprise at least one lower module (i.e., knee module 108 and/or hip module 110). In an embodiment, the at least one lower module may comprise at least one cable drum 102 disposed about at least a portion of the knee joint of the user and/or at least one assistance drum 116 disposed about at least a portion of the hip joint of the user to assist knee flexion and/or extension and/or hip flexion and/or extension, respectively.

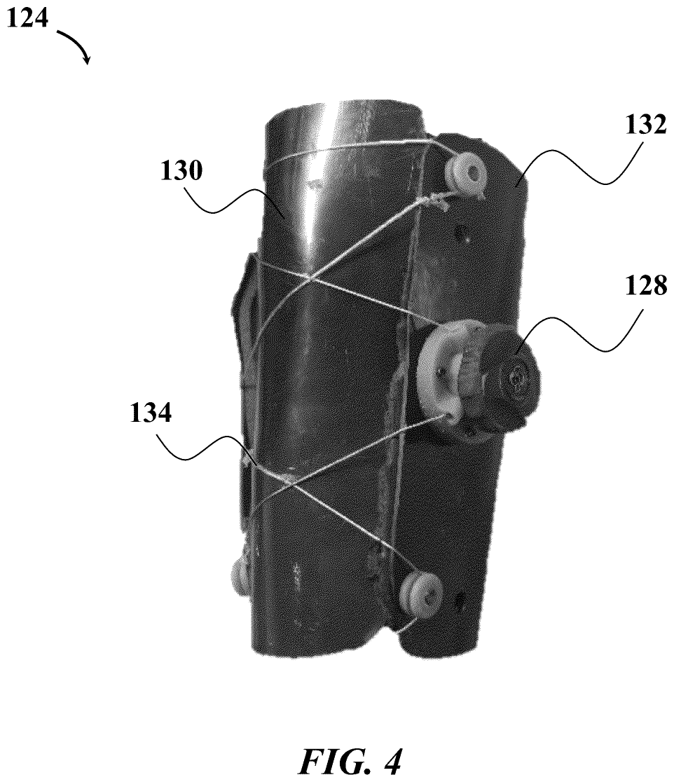

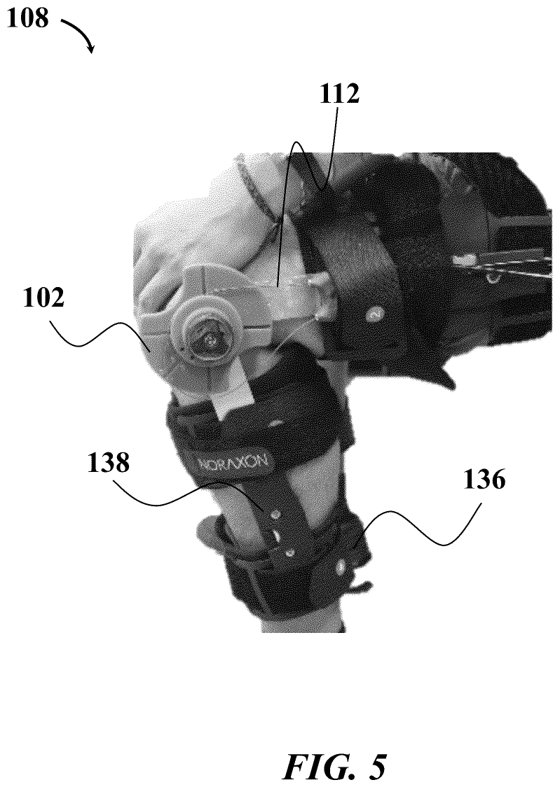

Furthermore, as shown in FIG. 4 and FIG. 5, the at least one lower module may comprise a hip brace and/or a knee brace configured to provide a pivot point for flexion-extension of the respective joints. Accordingly, in this embodiment, the at least one cable drum 102 and/or the at least one assistance drum 116 of the at least one lower module may be temporarily affixed to the knee brace and/or the hip brace, respectively. In addition, in some embodiments, in order to minimize friction and maintain tangential cable-drum contact while using different drum sizes, as shown in FIG. 3, in an embodiment, the lower attachment point for the at least two cables 112 within pulley system 144 may be configured to use three interchangeable tracks to ensure a tangential path of the cable to the drum.

In an embodiment, as shown in FIGS. 4-5 and FIG. 8, a commercial orthosis may be used to fabricate appendage work sharing apparatus 100. Accordingly, in this embodiment, as shown in FIG. 4 and FIG. 5, additionally modifications may be made to appendage work sharing apparatus 100, including but not limited to replacing at least one cuff 134, 136 of arm brace 124 and/or leg brace 138 with custom-built cuffs made from thermoplastic (e.g., acrylonitrile butadiene styrene (“ABS”)). Moreover, as shown in FIGS. 4-5, in this embodiment, arm brace 124 and/or leg brace 138 may comprise at least one tightening ratchet 128, such that the at least one tightening ratchet 128 may be in mechanical communication with at least one tightening wire 134. As such, in this embodiment, the at least one tightening ratchet 128, in association with the at least one tightening wire 134, may be configured to tighten the cuff 134, 136 to increase the contact area between the at least one appendage (e.g., arm and/or leg) of the user and cuff 134, 136, and as shown in FIGS. 4-5 and FIG. 8. In some embodiments, at least one additional cable drum 102 and/or at least one additional assistance drum 116 may be added to at least one module (e.g., elbow module 104, shoulder module 106, knee module 108, and/or hip module 110) of appendage work sharing apparatus 100 to increase capture of at least one flexion and/or extension motion of at least one joint of the user and/or transmission of the at least one flexion and/or extension motion from at least one module to at least one alternative module of appendage work sharing apparatus 100.

In addition, in an embodiment, the at least two pulley cables 112 and/or pulley system 144 may be routed and/or connected between the at least one upper module (i.e., elbow module 104 and/or shoulder module 106) and/or the at least one lower module, such that appendage work sharing apparatus may be configured to transfer a movement and/or force of the at least one lower appendage module to the at least one upper appendage module, and/or vice versa. Moreover, in some embodiments, the at least two pulley cables 112 may be routed and/or connected between only elbow module 104 and knee module 108 and/or shoulder module 106 and hip module 110.

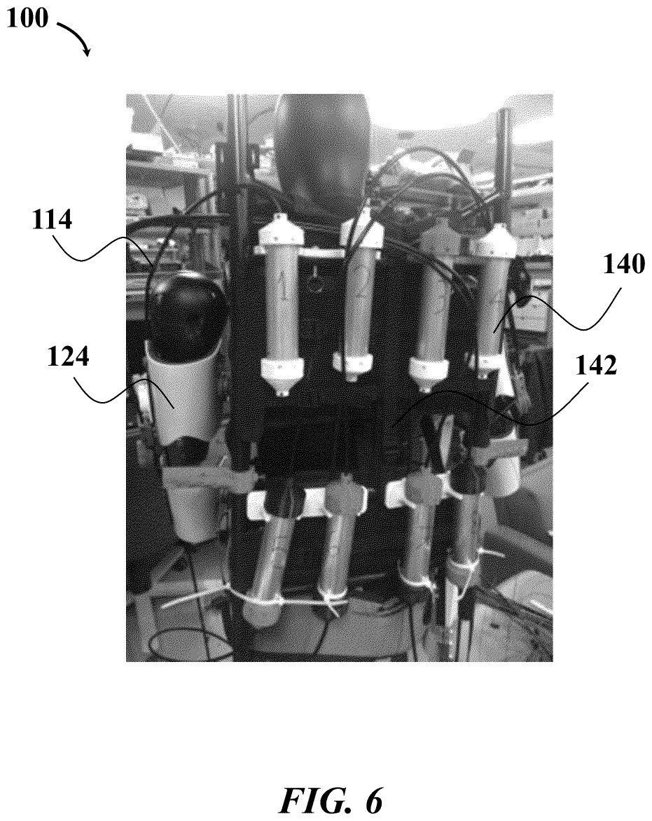

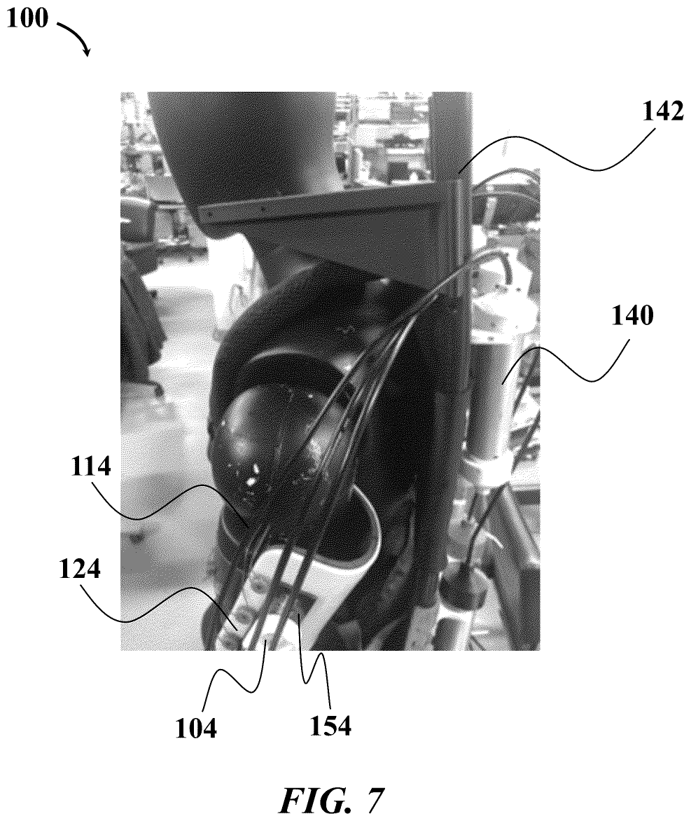

Additionally, in an embodiment, as shown in FIG. 6 and FIG. 7, appendage work sharing apparatus 100 may comprise a backpack frame 142 in mechanical communication with shoulder harness 118. In this manner, backpack frame 142 may be configured to accommodate shoulder harness 118, such that a total weight of the at least one upper module (e.g., elbow module 104 and/or shoulder module 106) may be evenly distributed about the upper body of the user. Accordingly, in this embodiment, the user may be able to wear appendage work sharing apparatus 100 for a substantial period of time without significant muscle fatigue from holding up the total weight of the at least one upper module with the upper body of the user. Furthermore, as shown in FIGS. 6-7, in an embodiment, appendage work sharing apparatus 100 may comprise at least one spring 140 configured to be temporarily affixed to at least a portion of backpack frame 142. As such, in this embodiment, the at least one spring 140 may be configured to optimize force transmission between the at least one lower module and/or the at least one upper module, and/or vice versa. In addition, with the at least one spring 140 temporarily affixed to at least a portion of backpack frame 142, more flexibility may be allowed within the linking component at the joint of each module, such that appendage work sharing apparatus 100 may be more user-friendly.

Moreover, as shown in FIG. 8, in conjunction with FIGS. 1-7, in an embodiment, the upper module and lower module facilitate work-sharing between upper and lower limb muscles. In this manner, in this embodiment, in order to enable more biomechanically coherent kinematic coupling between upper and lower limbs, the at least one upper module may be paired with the contralateral at least one lower module (e.g., right elbow connected to the left knee) such that appendage work sharing apparatus 100 may be configured to follow the natural upper-lower limb coordination during ambulatory movements.

As described above, in an embodiment, cable drum 102 and/or pulley system 144 may comprise adjustable ratchet mechanism 152, such that an amount of tension of the at least two pulley cables 112 may be altered according to the need and/or requirements of the user. Furthermore, in this embodiment, ratchet mechanism 152 may be comprise an engaged position and/or a disengage position, such that when ratchet mechanism is disposed in the engaged position the connected modules of appendage work sharing apparatus 100 may be paired and/or fully functional. In this manner, in this embodiment, when ratchet mechanism is disposed in the disengaged position, appendage work sharing apparatus may be configured to disconnect the connected modules, such that the connected modules may be unpaired and/or appendage work sharing apparatus 100 may be nonfunctional.

### Method of Use

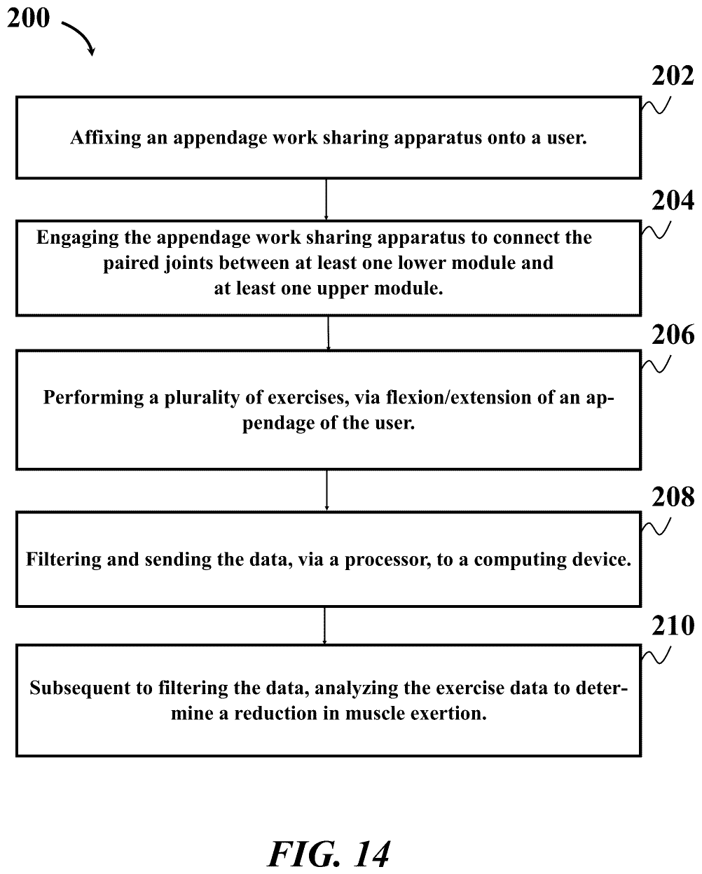

Referring now to FIG. 14, in conjunction with FIGS. 1-13, a method is depicted for capturing a movement of a targeted muscle group of a user and/or transferring it to another muscle group of the user, according to an embodiment of the present disclosure. The steps delineated are merely exemplary of a preferred order of capturing a movement of the targeted appendage and transferring it to another appendage of the user. The steps may be carried out in another order, with or without additional steps including therein. Additionally, the steps may be carried out with alternative embodiments of the variable resistance exercise apparel, as contemplated in the above description.

As shown in FIG. 14, in conjunction with FIGS. 1-13, the method 200 for capturing the movement of a targeted a muscle group of a user and/or transferring it to another muscle group using appendage work sharing apparatus 100 begins at step 202, affixing appendage work sharing apparatus 100 onto a user. In this embodiment, appendage work sharing apparatus 100 may be configured to conform to the exact specifications (e.g., body shape and/or height) of the user wearing the appendage work sharing apparatus 100, via the at least one adjustable cable and/or band of appendage work sharing apparatus 100. Next, at step 204 of method 200, the user may engage appendage work sharing apparatus 100, such that the at least one lower module (i.e., knee module 108 and/or hip module 110) and the at least one upper module (i.e., elbow module 104 and/or shoulder module 106) may be paired. In this manner, in this embodiment, the appendage work sharing apparatus 100 may be configured to transfer, via the linking component of work sharing apparatus 100, the movement (e.g., a muscle exertion) of a targeted muscle group in mechanical communication with at least one joint and/or at least one force applied to the at least one joint during the movement to at least one alternative muscle group and/or at least one alternative joint of at least one alternative appendage of the body. For example, in some embodiments, the knee joint may be targeted by the user, such that when movement occurs, work appendage apparatus 100 may be configured to transfer the movement and/or force of the quadriceps to at least one shoulder of the user. Then, at step 206, the user performs a plurality of exercises (e.g., weight lifting) and/or activities (e.g., running, walking, jumping, picking-up items, etc.), which may comprise flexion and/or extension of the appendage of the user. Further, after performing the plurality of exercises and/or activities, at step 208, the at least one sensor communicatively coupled to the computing device of appendage work sharing apparatus 100 may be configured to transmit exertion data collected from the use of appendage work sharing apparatus 100, such that the exertion data may be filtered and/or recorded in a memory of the computing device, via the at least one processor. Finally, at step 210, subsequent to filtering the data, the computing device associated with appendage work sharing apparatus 100 may be configured to display the exertion data may be displayed on a display device associated with the computing device, such that the computing device and/or a user may be configured to analyze the exertion data to determine a reduction in muscle exertion by the targeted muscle group of the user while appendage work sharing apparatus is engaged 100.

In some embodiments, the computing device may be configured to transmit a notification indicative of a level of reduction (e.g., a percent reduction in muscle exertion) by the targeted muscle group to the user, via a tactile, visual, and/or auditory output. Additionally, in these other embodiments, the computing device may be communicatively coupled and/or in mechanical communication with the at least one ratchet mechanism 152, such the user, via at least one user-interface, may engage and/or disengage appendage work sharing apparatus 100, via at least one operational command of the computing device. In this manner, when the exertion data is transmitted to the computing device of the appendage work sharing apparatus 100, the computing device may be configured to provide a notification indicative of at least one recommendation to improve the exercise and/or activity, in real time, such that optimal muscle exertion reduction is achieve for the at least one targeted muscle group.

In some embodiments, the appendage work sharing apparatus 100 may comprise at least one motor 154 in mechanical communication with the linking component of appendage work sharing apparatus 100. In this manner, at least one motor 154 may be disposed about at least a portion of appendage work sharing apparatus 100, including but not limited to, at least a portion of at least one cable drum 102, at least one assistance drum 116, shoulder harness 118, and/or backpack frame 142, as shown in FIG. 7. As such, in these other embodiments, based on the exertion data provided by the at least one sensor, the computing device may be communicatively coupled and/or in mechanical communication with at least one motor 154 at each module of appendage work sharing apparatus 100, such that the computing device may be configured to actively (e.g., at least one actuator) and/or passively (e.g., hydraulics) flex and/or extend pulley system 144 and/or the at least two cables 112 of the linking component, in real-time, simultaneously with the movement of the user. In this manner, the computing device and/or at least one motor 154 may be configured to aid the user in optimal muscle exertion reduction (e.g., a 10% reduction, a 25% reduction, a % 50 percent reduction, and/or a 100% reduction) for the targeted muscle group (e.g., aiding in the transfer of the muscle exertion from the knee to the elbow and/or vice versa). Moreover, in these other embodiments, the user may be configured to input the optimal muscle exertion reduction, via the at least one user interface, communicatively coupled to the computing device of appendage work sharing apparatus 100. As such, subsequent to receiving the muscle exertion reduction input from the user, the at least one processor of the computing device may be configured to output an electrical signal corresponding to the selected optimal exertion reduction to at least one motor 154, such that at least one motor 154 to reduce muscle exertion, accordingly (e.g., a 10% reduction).

The following examples are provided for the purpose of exemplification and are not intended to be limiting.

### EXAMPLES

### Example 1

### Determination of Lower Module Work Sharing

Strenuous activity and exercise were performed by a group of users using appendage work sharing apparatus 100 (hereinafter “the device”). In the current example, five users were selected to perform the strenuous activity and exercises using the appendage work sharing apparatus. The resulting exercise data and profile is provided below.

Four of the five participants were right-side dominant. Each user was instructed to wear light sports clothing for instrumenting the device and an electromyography (hereinafter “EMG”) sensor. The device was subsequently adjusted and/or conformed to the user once the user donned the device for proper fit to their arms and legs and for proper joint alignment between the device and the user's anatomical joints.

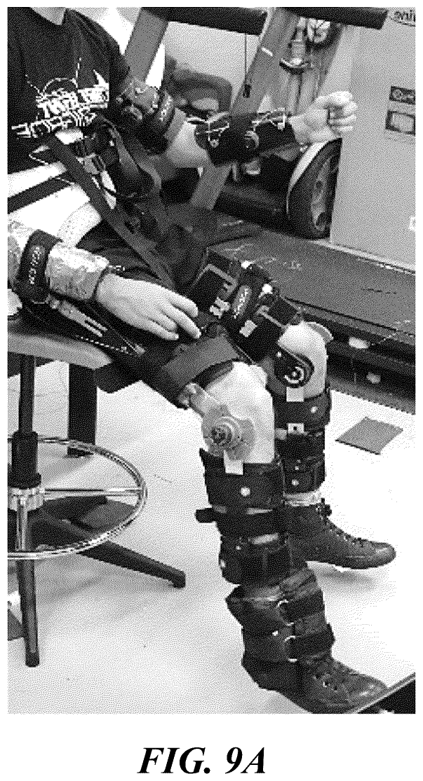

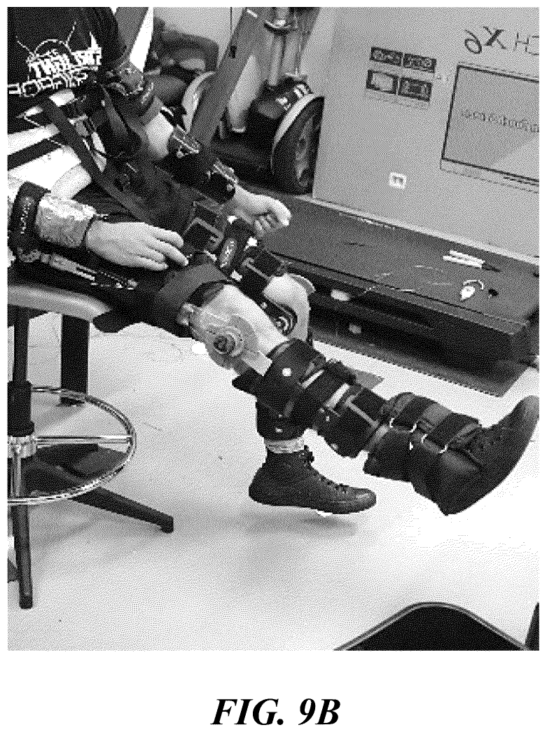

As shown in FIGS. 6-7, in conjunction with FIGS. 9A-11B, the arm cuffs were tightened using the ratchet to cinch the arm cuffs, and the legs were secured using Velcro straps. The users performed three different exercises: Single leg (hereinafter “E1”), Sit-to-Stand (hereinafter “E2”), and Step-up (“E3”). The user wore the device throughout the entire data collection session. Each exercise was performed in two conditions: OFF condition, when the device was disengaged to disconnect the paired joints between the lower modules and upper modules, and ON condition, when the device was engaged to allow the lower joint(s) to share the work with the upper limb joint(s).

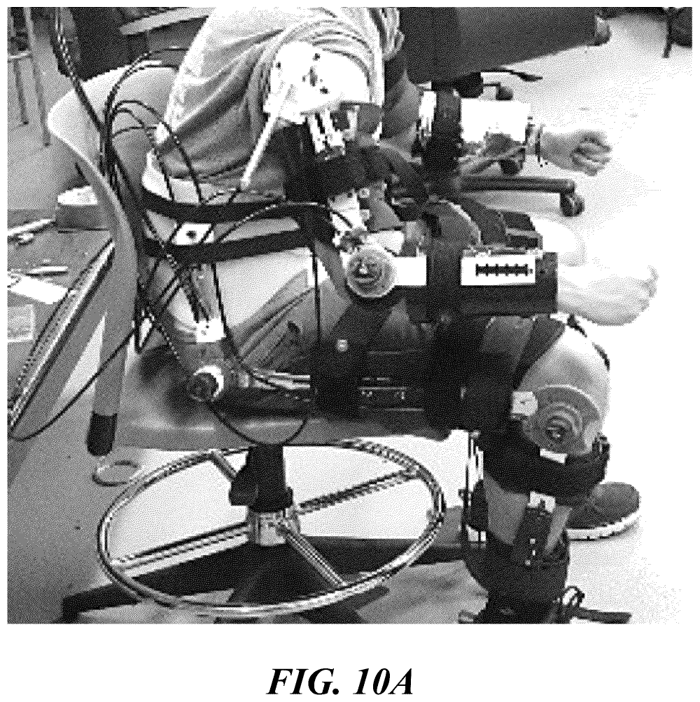

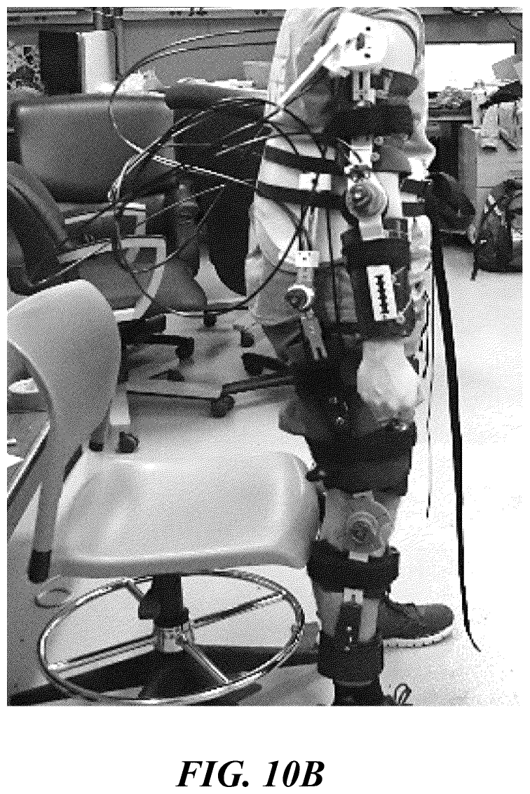

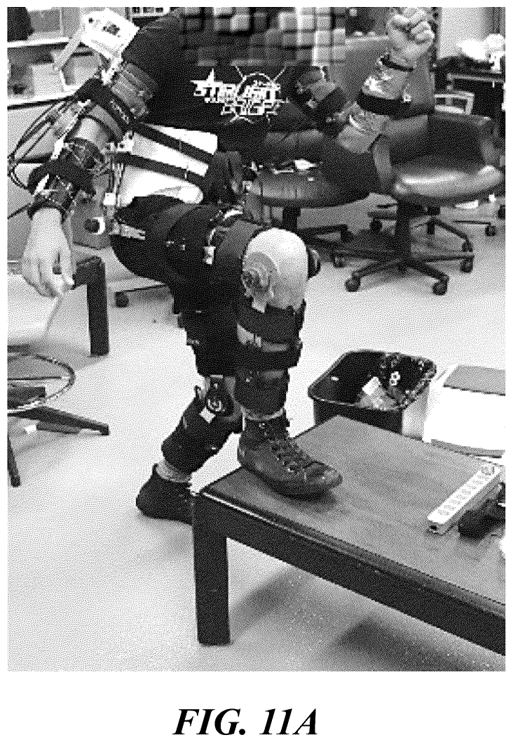

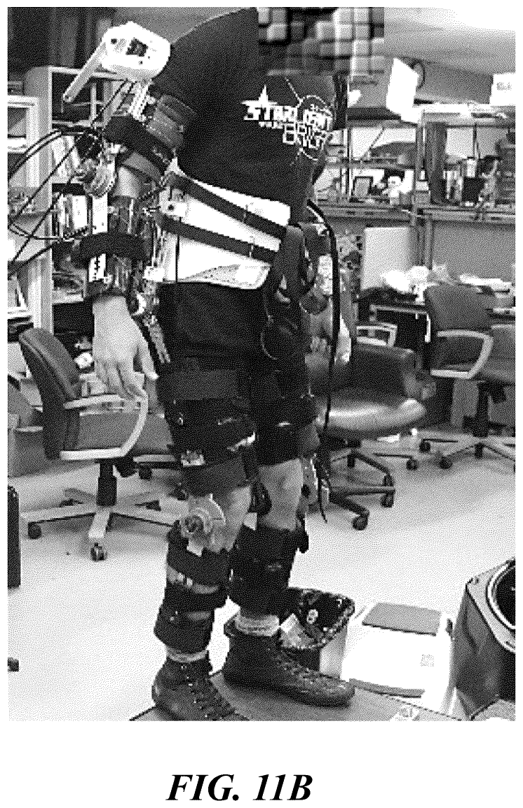

As depicted in FIGS. 9A-9B, the E1 consisted of the user extending their knee joint three times from a sitting position. This exercise was repeated four times for each leg, with or without a weight (e.g., 6 lbs.) attached to the ankle of the user, for both OFF and ON conditions. As depicted in FIGS. 10A-10B, the E2 consisted of the user standing up from a sitting position. Accordingly, the user sat down on an adjustable chair to ensure that the feet of the user were firmly on the floor and knee joints of the user were at 90 degrees. After the sitting position was verified, the user then stood up and sat down three times. This exercise was repeated four times for OFF and ON conditions. Finally, as depicted by FIGS. 11A-11B, E3 consisted of the user stepping up and down three times from a table of a predetermined height (e.g., 16 inches) with the dominant leg of the user.

As all three exercise tests (E1, E2, and E3) involved knee extension, the Rectus Femoris muscle activation was used as the primary metric to assess the work-sharing of upper module and lower module through the device. Moreover, the surface electromyography (EMG) sensors were placed on the Biceps, lateral Triceps, Rectus Femoris, and Gastrocnemius Medialis of the user. Placement of the EMGs was done following the manufacturer's guidelines. Additionally, joint kinematics were recorded using a set of wearable Inertial Measurement Units (“IMUs”), which were placed on the forearms, upper arms, thighs, shanks, upper thoracic, and pelvis of the user, following the manufacturer's guidelines.

To maintain a consistent cadence across multiple repetitions and throughout three different exercises, all users were instructed to follow an auditory cue to keep the cadence at 6 seconds per cycle, which was controlled by an Arduino Uno connected to a soundboard. Within each cycle, a monotone sound was generated, 3 seconds apart, to inform the transition timing between two phases: extension and flexion (E1), sit to stand and stand to sit (E2), and step up and step down (E3). The same Arduino was interfaced with the EMG and IMU sensor systems to record the cadence signals simultaneously for data parsing during post-processing.

Additionally, all data was recorded using Noraxons' MR3 software, which synchronized EMG and motion data, sampled at 2000 Hz and 200 Hz, respectively. The data process and analysis were done using MATLAB software. The time series EMG and motion data were normalized to represent 0-100% cycle to obtain linear envelope, then averaged over the four cycles (repetitions). The integrated EMG (“iEMG”) of Rectus Femoris (hereinafter “RF”) was computed and used as the main variable to assess the difference between OFF and ON conditions for each exercise performed. Further, ON condition results were calculated as a percentage of OFF condition within each exercise.

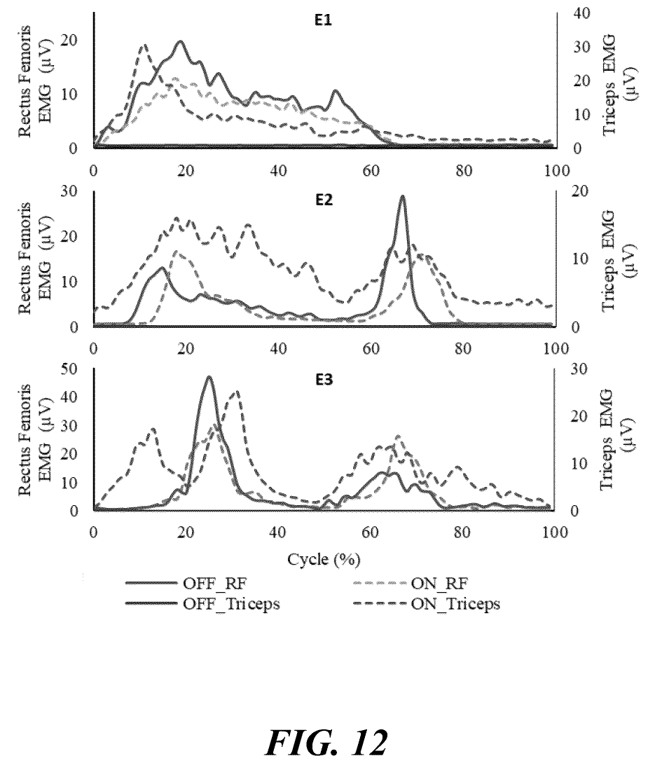

FIG. 12 depicts a plot illustrating an average linear envelope of an EMG during a first, a second, and a third exercise of a user, according to an embodiment of the present disclosure. For all three exercises, the Triceps (e.g., elbow extensor) was engaged to share the work of the Biceps Femoris (e.g., knee extensor) during the device ON conditions across all three exercises (i.e., blue dotted lines), indicated by the attenuation in the peaks of the RF activation as compared to the device OFF condition (red dotted lines). Additionally, it should be noted that the Triceps EMG data of OFF conditions (i.e., blue solid lines) are zero, thus not visible in the linear envelop, as shown in FIG. 12, since there were no pairing and elbow flexion/extension involved in OFF conditions.

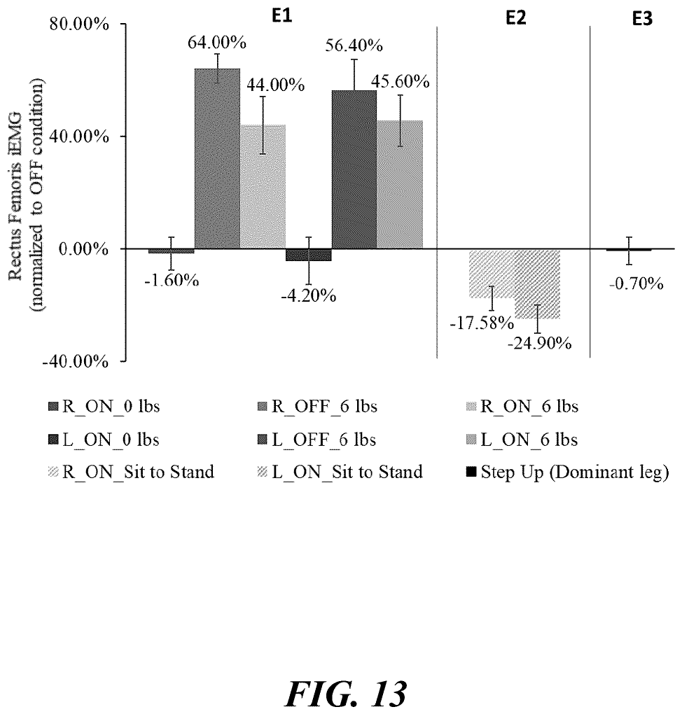

In single-leg exercise (E1), RF is activated during the first half of the cycle when knee extension was performed, showing the peak at around 20% of the cycle. The Triceps activation aligns with the RF activation pattern with its peak at around 10% of the cycle, indicating the most work sharing occurred at the early phase of the knee extension. As shown in FIG. 13, the total muscle activation of RF iEMG was visibly reduced, without load by 1.6% for the right leg and by 4.2% for the left leg, respectively, as compared to OFF condition. Furthermore, when a weight load was added to the ankle (e.g., 6 lbs.) when device was disengaged (OFF), the RF iEMG was increased by 64% and 56.40% for the right and left leg, respectively, as compared to the no-load condition. In this manner, as shown in FIG. 12 and FIG. 13, with the device engaged (ON), the RF iEMG was reduced by around 31% (64% to 44%) and 19% (56.40% to 45.6%) for the right and left leg, respectively. The results indicate that the work-sharing between knee and elbow was achieved using the device. Additionally, a greater effect was shown when the device was under the presence of an external load.

In accordance with E1 results, as shown in FIG. 12 and FIG. 13, the sit-to-stand exercise (E2) showed 17.5% and 25% reduction in the RF iEMG for the right and the left leg, respectively, indicating similar levels of work-sharing were achieved on both sides through the device. Considering that the motion during 32 is symmetrical (e.g., identical joint motion and load between the right and left side), one observation was that the reduction should have been equivalent. However, after collecting the exercising data, a difference in the reduction of RF iEMG could be noted between the right and left knee. Four out of five subjects were right leg dominant, which may indicate that the non-dominant side (left knee) benefits more from work-sharing than the dominant side (right knee). Additionally, as shown in FIG. 12, during the E2 exercise, the RF was engaged during the first half (sit-to-stand) of the cycle for knee extension as well as during the second half (stand to sit) of the cycle to aid knee from buckling. Similarly, Triceps activation occurred throughout the cycle whose peaks aligned with those of RF.

Finally, the RF reduction seemed less effective during the E3 exercise, as shown in FIG. 12 and FIG. 13. The lack of effectiveness in the device in E3 is evidenced by the near-zero reduction (−0.7%) in the group average RF iEMG data. Of note, the lack of effectiveness may have been due to an out-of-phase of elbow-knee motion coordination where elbow extension was not synchronized well with the knee extension motion, leading to minimal work-sharing between the two joints. This is further evidenced in FIG. 12, where the second peak of RF iEMG for E3 was higher in OFF condition than that of ON condition. Since the current device design only permits a direct motion transfer and kinematics coupling between the upper module and lower module, the synchronization of the motion of the paired joints in terms of timing and direction is crucial to achieving the desired outcomes. Otherwise, the contribution of upper limb muscles to lower limb joint movement is not absolutely guaranteed.

In summary, appendage work sharing apparatus 100 may provide an external mechanical pathway to transmit a movement and/or force from at least one upper appendage joint and/or muscle group in mechanical communication with the at least one upper appendage joint to at least one lower appendage joint and/or muscle group in mechanical communication with the at least one lower appendage joint, and/or vice versa. As such, appendage work sharing apparatus 100 may allow lower appendage muscles to share the work (e.g., the muscle exertion) with upper appendage muscles and/or upper appendage muscles to share the work with the lower appendage muscles. This, in turn, optimizes and effectively reduces the work done by the at least one lower appendage muscle and/or the at least one upper appendage muscle in ambulatory movements. Additionally, in this manner, this, in turn, optimizes and effectively reduces the amount of force applied to the at least one lower appendage joint and/or the at least one upper appendage joint in ambulatory movements.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

N. C. f. H. Statistics, “Summary health statistics: National health interview survey, 2018,” Centers for Disease Control and Prevention, hi, 2017.
S. M. Bradley and C. R. Hernandez, “Geriatric Assistive Devices,” Am Fam Physician, vol. 15, no. 84(4), pp. 405-411, 2011.
M. Sehgal, J. Jacobs, and W. S. Biggs, “Mobility Assistive Device Use in Older Adults,” Am Fam Physician, vol. 15, no. 103(12), pp. 737-744, 2021.
B. C. Clark, T. M. Manini, N. R. Ordway, and L. L. Ploutz-Snyder, “Leg muscle activity during walking with assistive devices at varying levels of weight bearing,” (in eng), Arch Phys Med Rehabil, vol. 85, no. 9, pp. 1555-60, September 2004, doi: 10.1016/j.apmr.2003.09.011
C. Dewar and K. D. Martin, “Comparison of Lower Extremity E.M.G. Muscle Testing With Hands-Free Single Crutch vs Standard Axillary Crutches,” Foot & Ankle Orthopedics, vol. 5, no. 3, p. 2473011420939875, 2020, doi: 10.1177/2473011420939875.
Y. Sankai, “H.A.L.: Hybrid assistive limb based on cybernics,” in Robotics research: Springer, 2010, pp. 25-34.
L. Wang, S. Wang, E. H. van Asseldonk, and H. van der Kooij, “Actively controlled lateral gait assistance in a lower limb exoskeleton,” in 2013 IEEE/RSJ International Conference on Intelligent Robots and Systems, 2013: IEEE, pp. 965-970.
H. K. Kwa, J. H. Noorden, M. Missel, T. Craig, J. E. Pratt, and P. D. Neuhaus, “Development of the IHMC mobility assist exoskeleton,” in 2009 IEEE international conference on robotics and automation, 2009: IEEE, pp. 2556-2562.
A. Esquenazi, M. Talaty, A. Packel, and M. Saulino, “The ReWalk powered exoskeleton to restore ambulatory function to individuals with thoracic-level motor-complete spinal cord injury,” American journal of physical medicine & rehabilitation, vol. 91, no. 11, pp. 911-921, 2012.
K. A. Strausser and H. Kazerooni, “The development and testing of a human machine interface for a mobile medical exoskeleton,” in 2011 IEEE/RSJ International Conference on Intelligent Robots and Systems, 2011: IEEE, pp. 4911-4916.
D. Sanz-Merodio, M. Cestari, J. C. Arevalo, X. A. Carrillo, and E. Garcia, “Generation and control of adaptive gaits in lower-limb exoskeletons for motion assistance,” Advanced Robotics, vol. 28, no. 5, pp. 329-338, 2014.
H. Kazerooni and R. Steger, “The Berkeley lower extremity exoskeleton,” 2006.
C. J. Walsh, K. Endo, and H. Herr, “A quasi-passive leg exoskeleton for load-carrying augmentation,” International Journal of Humanoid Robotics, vol. 4, no. 3, pp. 487-506, 2007.
E. Guizzo and H. Goldstein, “The rise of the body bots [robotic exoskeletons],” IEEE spectrum, vol. 42, no. 10, pp. 50-56, 2005.
D. Shi, W. Zhang, W. Zhang, and X. Ding, “A Review on Lower Limb Rehabilitation Exoskeleton Robots,” Chinese Journal of Mechanical Engineering, vol. 32, no. 1, p. 74, 2019/08/30 2019, doi: 10.1186/s10033-019-0389-8.
A. J. Young and D. P. Ferris, “State of the Art and Future Directions for Lower Limb Robotic Exoskeletons,” IEEE Transactions on Neural Systems and Rehabilitation Engineering, vol. 25, no. 2, pp. 171-182, 2017, doi: 10.1109/TNSRE.2016.2521160.
Y. Tingfang, C. Marco, O. Calogero Maria, and V. Nicola, “Review of assistive strategies in powered lower-limb orthoses and exoskeletons,” Robotics and Autonomous Systems, vol. 64, pp. 120-136, 2015, doi: https://doi.org/10.1016/j.robot.2014.09.032.
W. Van Dijk, H. Van der Kooij, and E. Hekman, “A passive exoskeleton with artificial tendons: Design and experimental evaluation,” in 2011 IEEE International Conference on Rehabilitation Robotics, 2011: IEEE, pp. 1-6.
S. H. Collins, M. B. Wiggin, and G. S. Sawicki, “Reducing the energy cost of human walking using an unpowered exoskeleton,” Nature, vol. 522, no. 7555, pp. 212-215, 2015.

L. Xie, G. Huang, L. Huang, S. Cai, and X. Li, “An Unpowered Flexible Lower Limb Exoskeleton: Walking Assisting and Energy Harvesting,” IEEE/ASME Transactions on Mechatronics, vol. 24, no. 5, pp. 2236-2247, 2019, doi: 10.1109/TMECH.2019.2933983.
J. Park, “Synthesis of natural arm swing motion in human bipedal walking,” Journal of biomechanics, vol. 41, no. 7, pp. 1417-1426, 2008.
P. Meyns, S. M. Bruijn, and J. Duysens, “The how and why of arm swing during human walking,” Gait & posture, vol. 38, no. 4, pp. 555-562, 2013.
P. Jaeheung, “Synthesis of natural arm swing motion in human bipedal walking,” Journal of Biomechanics, vol. 41, no. 7, pp. 1417-1426, 2008, doi: https://doi.org/10.1016/j.jbiomech.2008.02.031.
P. Meyns, S. M. Bruijn, and J. Duysens, “The how and why of arm swing during human walking,” (in eng), Gait Posture, vol. 38, no. 4, pp. 555-62, September 2013, doi:
R. Lockhart, P. Janphuang, D. Briand, and N. F. de Rooij, “A wearable system of micromachined piezoelectric cantilevers coupled to a rotational oscillating mass for on-body energy harvesting,” in 2014 IEEE 27th international conference on micro electro mechanical systems (MEMS), 2014: IEEE, pp. 370-373.
G. Terlecka, J. Blums, A. Vilumsone, I. Gornevs, and Z. Pavare, “Wearable power Harvester for medical applications,” in S.H.S. Web of Conferences, 2014, vol. 10: EDP Sciences, p. 00046.
M. Geisler et al., “Human-motion energy harvester for autonomous body area sensors,” Smart materials and structures, vol. 26, no. 3, p. 035028, 2017.
S. Brunner, M. Gerst, and C. Pylatiuk, “Design of a body energy harvesting system for the upper extremity,” Current Directions in Biomedical Engineering, vol. 3, no. 2, pp. 331-334, 2017.
“Ultium E.M.G. Hardware User Manual,” ed: Inc., Noraxon U.S.A., 2018.
“myoMOTION Hardware User Manual,” ed: Noraxon U.S.A. Inc., 2018.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. An appendage work sharing apparatus comprising:
a linkage component comprising at least one pulley, at least two cables, or both, wherein the at least two cables are in mechanical communication with the at least one pulley, whereby the linkage component has a variable tension;
a plurality of modules in mechanical communication with the linkage component, wherein each of the plurality of modules is disposed at a predetermined joint of a user; and
wherein at least one module of the plurality of modules is configured to transfer a force at the predetermined joint, via the linkage component, to at least one alternative module of the plurality of modules disposed about at least one alternative joint.

2. The appendage work sharing apparatus of claim 1, wherein the plurality of modules further comprises:
a base;
at least one cable drum temporarily affixed to the base, wherein the linkage component is disposed about at least a portion of the at least one cable drum; and
at least one ratchet mechanism in mechanical communication with the at least one cable drum, wherein the at least one ratchet mechanism is configured to alternate the at least one cable drum from a disengaged stage to an engaged stage, an engaged state to a disengaged state, or both, thereby adjusting the tension of the linkage component.

3. The appendage work sharing apparatus of claim 2, wherein the plurality of modules further comprises at least one assistance drum temporarily affixed to at least one alternative base, wherein the at least one assistance drum is disposed about at least a portion of a ball-and-socket joint of the user, whereby a center of the at least one assistance drum is positioned at a center of the ball-and-socket joint.

4. The appendage work sharing apparatus of claim 2, wherein when the at least one ratchet mechanism is in the engaged state, the linking component has tension, pairing at least one cable drum of at least one module of the plurality of module with the at least one cable drum of at least one alternative module of the plurality of modules.

5. The appendage work sharing apparatus of claim 3, wherein when the at least one ratchet mechanism is in the disengaged state, the linking component has minimal tension, thereby unpairing at least one cable drum of at least one module of the plurality of module with the at least one cable drum of at least one alternative module of the plurality of modules.

6. The appendage work sharing apparatus of claim 5, wherein the at least one assistance drum is configured capture abduction, adduction, or both at the ball-and-socket joint of a user.

7. The appendage work sharing apparatus of claim 6, wherein the at least one cable drum is configured to capture flexion, extension, or both at the predetermined joint of the user.

8. The appendage work sharing apparatus of claim 7, wherein the at least one cable drum, the at least one assistance drum, or both of at least one module of the plurality of modules is in mechanical communication with the at least one cable drum, the at least one assistance drum, or both of at least one alternative module of the plurality of modules, via the linkage mechanism.

9. The appendage work sharing apparatus of claim 1, wherein the linkage component comprises a motion coupling ratios selected from the group consisting of 1:1, 1.5:1, 2:1, or a combination thereof between the at least one module in mechanical communication with the at least one alternative module.

10. The appendage work sharing apparatus of claim 2, further comprising:
a computing device having at least one processor communicatively coupled to at least one sensor, the at least one sensor being configured to detect an exertion by at least one muscle in mechanical communication with the predetermined joint, wherein the at least one sensor is disposed about at least one portion of each of the plurality of modules; and
at least one motor in mechanical communication with the linking component, the at least one motor being disposed about at least portion of the base of each of the plurality of modules, wherein the at least one motor is communicatively coupled with the at least one processor of the computing device.

11. The appendage work sharing apparatus of claim 10, wherein subsequent to the at least one sensor detecting an exertion by at least one muscle in mechanical communication with the predetermined joint, the at least one processor is configured to actuate the at least one motor at the predetermined joint, thereby reducing muscle exertion by the at least one muscle at the predetermined joint, in real-time, simultaneously with the movement of the user.

12. A system for capturing a movement of a targeted muscle group of a user and transferring it to at least one alternative muscle group of the user, the system comprising:
a linkage component comprising at least one pulley, at least two cables, or both, wherein the at least two cables are in mechanical communication with the at least one pulley, whereby the linkage component has a variable tension;
a plurality of modules in mechanical communication with the linkage component, wherein each of the plurality of modules is positioned at a predetermined joint of
a user;
at least one arm brace;
at least one leg brace;
wherein at least one portion of at least one of plurality of modules associated with an upper appendage joint of the user is disposed about at least one portion of a surface of the at least one arm brace;
wherein at least one portion of at least one alternative module of the plurality of modules associated with a lower appendage joint of the user is disposed about at least one portion of a surface of the at least one leg brace; and
wherein at least one module of the plurality of modules is configured to transfer a force at the predetermined joint to at least one alternative module of the plurality of modules.

13. The system of claim 12, wherein the plurality of modules further comprises:
a base;
at least one cable drum temporarily affixed to the base, wherein the linkage component is disposed about at least a portion of the at least one cable drum; and
at least one ratchet mechanism in mechanical communication with the at least one cable drum, wherein the at least one ratchet mechanism is configured to alternate the at least one cable drum from a disengaged stage to an engaged stage, an engaged state to a disengaged state, or both, thereby adjusting the tension of the linkage component.

14. The system of claim 13, wherein the plurality of modules further comprises at least one assistance drum temporarily affixed to at least one alternative base, wherein the at least one assistance drum is disposed about at least a portion of a ball-and-socket joint of the user, whereby a center of the at least one assistance drum is positioned at a center of the ball-and-socket joint.

15. The system of claim 12, further comprising a shoulder harness, wherein at least one additional alternative module of the plurality of modules associated with at least one alternative upper appendage joint of the user is disposed about at least one portion of a surface of the shoulder harness.

16. The system of claim 14, wherein the at least one cable drum, the at least one assistance drum, or both of at least one module of the plurality of modules is in mechanical communication with the at least one cable drum, the at least one assistance drum, or both of at least one alternative module of the plurality of modules, via the linkage mechanism.

17. The system of claim 13, further comprising:
a computing device having at least one processor communicatively coupled to at least one sensor, the at least one sensor being configured to detect an exertion by at least one muscle in mechanical communication with the predetermined joint, wherein the at least one sensor is disposed about at least one portion of each of the plurality of modules; and
at least one motor in mechanical communication with the linking component, the at least one motor being disposed about at least portion of the base of each of the plurality of modules, wherein the at least one motor is communicatively coupled with the at least one processor of the computing device.

18. The system of claim 17, wherein subsequent to the at least one sensor detecting an exertion by at least one muscle in mechanical communication with the predetermined joint, the at least one processor is configured to actuate the at least one motor at the predetermined joint, thereby reducing muscle exertion by the at least one muscle at the predetermined joint, in real-time, simultaneously with the movement of the user.

19. A method of capturing a movement of a targeted muscle group of a user and transferring it to at least one alternative muscle group of the user, via an appendage work sharing apparatus, the method comprising:
affixing the appendage work sharing apparatus to the user, the appendage work sharing apparatus comprising:
a linkage component comprising at least one pulley, at least two cables, or both, wherein the at least two cables are in mechanical communication with the at least one pulley, whereby the linkage component has a variable tension;
a plurality of modules in mechanical communication with the linkage component, wherein each of the plurality of modules is disposed at a predetermined joint of a user; and
wherein at least one module of the plurality of modules is configured to transfer a force at the predetermined joint, via the linkage component, to at least one alternative module of the plurality of modules disposed about at least one alternative joint;
engaging, via the at least one ratchet mechanism, the appendage work sharing apparatus; and
performing, via the appendage work sharing apparatus a plurality of exercises, activities, or both, wherein the movement of the targeted muscle group is transferred to at least one alternative muscle group of the user, thereby reducing a total muscle exertion of the targeted muscle group during the plurality of exercises, activities, or both.

20. The method of claim 19, further comprising the steps of:
transmitting, via at least one sensor communicatively coupled to a computing device associated with the appendage work sharing apparatus, the computing device having at least one processor, exertion data relating to the total muscle exertion of the targeted muscle group during the plurality of exercises, activities, or both;
actuating, via the at least one processor, at least one motor disposed about at least a portion of each of the plurality of modules, the at least one motor being in mechanical communication with the linking component, wherein the at least one motor is communicatively coupled to the at least one processor; and
assisting, via at least one motor, transfer of the movement of the targeted muscle group to at least one alternative muscle group of the user based on the transmitted exertion data, thereby optimizing total muscle reduction of the targeted muscle group during the plurality of exercises, activities, or both.
